(19) United States
(12) Patent Application Publication
(10) Pub. No.: US 2009/0303666 A1
(43) Pub. Date: Dec. 10, 2009

(54) THERMOPLASTIC ELECTRICAL ENCLOSURE

(76) Inventors: Christopher Andrew Brizes, Westlake, OH (US); James Carroll McWilliams, West Chester, OH (US)

Correspondence Address: ULMER & BERNE LLP;ATTN: DIANE BELL, 600 VINE STREET, SUITE 2800, CINCINNATI, OH, 45202, US

(21) Appl. No.: 12/136,440

(22) Filed: Jun. 10, 2008

(51) Int. Cl. H02B 1/26

(52) U.S. Cl. 361/658

(57) ABSTRACT

An electrical enclosure is made of a thermoplastic material such as a polycarbonate material. The enclosure includes a box and a lid hinged to the box along its back edge. A top edge of the box and a bottom edge of the lid are shaped to engage and hold a resilient seal when the lid is closed. The lid may be moved between an open position and a closed position. The lid is held in the closed position by a tongue and dog fastener arrangement. One of the lid and box has a dog that projects from the front edge of the box while a resilient tongue projects from the other of the box and lid. The tongue has an opening that receives the dog when the lid is closed in order to hold the lid closed. An extension of the tongue projects past the opening and at an angle to create a space for manual engagement to pry the tongue away from the dog when it is required to open the box. A pair of hasp members, one part of the tongue and the other part of the one of the box and lid from which the dog projects, are aligned with each other when the lid is closed. The hasp members have holes that permit a lock or other retaining pin to be inserted in order to inhibit unintentional opening of the enclosure. The enclosure includes external mounting flanges to secure the enclosure to a supporting structure. The enclosure also may include internal rails integrally formed with the box for mounting electrical components. No metal inserts are included in the enclosure.

### TECHNICAL FIELD

The disclosure relates to electrical enclosures formed of thermoplastic.

### BACKGROUND

In general an electrical enclosure houses electrical components, electronics, or other devices or paraphernalia that require some degree of protection from dust, water, elements, environment, etc. An electrical enclosure must:

offer an acceptable degree of protection;

include some way of mounting components inside the enclosure, the more utilitarian, the better, including the ability to mount components to the backpanel, on a deadfront or inner door, on panel mounts or on hinges within the enclosure;

include some method of mounting the enclosure externally, again, the more utilitarian, the better, to a telephone pole, to an electrical panel, to a wall or through a wall, etc.;

meet all applicable standards such as UL 746C, ETL, NEMA, IP, and/or others.

In the past electrical enclosures have been made of steel, bulk molding compound (BMC), various polycarbonates or other thermoplastic materials. Enclosures made of various materials, including polycarbonate, have been designed that meet the National Electrical Manufacturers Association (NEMA) 4× standards for resistance to impact, water, flames, and corrosion.

Typically, electrical enclosures made of polycarbonate or other thermoplastic material have been made with metal inserts to receive various fasteners, particularly to receive machine screws. Machine screws have been screwed into the molded-in metal inserts to mount components inside the enclosure or to hold the top in place. One such enclosure is illustrated in U.S. Pat. No. 7,224,283. In production this enclosure has metal inserts in housing that align with holes in the corners of the door. Machine screws that fit the inserts are used, in part, to hold the door closed. The requirement for inserts has made the process of molding plastic electrical enclosures labor-intensive and expensive.

The enclosure shown in U.S. Pat. No. 7,224,283 also has a tongue with apertures that receive projections from the side of the housing when the door is fully closed. This arrangement has proven hard to use since a tool is necessary to pry the tongue out of contact with the projections before the door can be opened.

The mounting shown in U.S. Pat. No. 6,604,798 eliminates the need for metal inserts in the mold to provide panel mounts inside the housing. Some NEMA 4× enclosures have heretofore used metal inserts as part of the housing to secure the door in a closed position to achieve a NEMA 4× rating. Other thermoplastic electrical enclosures have used toggle fasteners to secure the door. These fasteners require assembly of multiple components, adding to their cost of manufacture.

### SUMMARY

This application discloses and claims a thermoplastic electrical enclosure comprising a box and a lid. The box has opposed front and back walls, side walls connected to the front and back walls and a bottom integrally formed with the front, side and back walls. The sidewalls have top edges at least partially defining an opening at the top of the box. The lid has a top wall and a peripheral wall configured to engage the top edges of the side walls of the box. A resilient seal is disposed between the peripheral wall of the lid and the top edges of the walls of the box. A hinge connects the lid to the box. The hinge comprises a rod element defining a hinge axis and is integrally formed with one of the lid and box. The hinge also comprises a hook element proportioned to engage the rod element, the hook element being integrally formed with the other of the box and lid. The hinge is positioned along the back wall of the box and enables the lid to rotate about the hinge axis between open and closed positions.

The enclosure further includes a snap closure that can be manually operated. The snap closure includes a dog projecting from the front wall of the box and a tongue extending from the lid and having an opening to receive the dog. The tongue has a proximal portion and a distal extension. The proximal portion of the tongue is integrally formed with the lid. The distal extension forms a finger lift portion. The finger lift portion is integrally formed with the proximal portion and extends at an angle to the front wall of the box. The opening in the tongue is located between the terminal edge of the tongue and the peripheral seat of the lid. The finger lift portion has a terminal edge sufficiently far from where the tongue joins the lid and spaced from the front wall of the box when the lid is in the closed position to enable manual release of the hole from the dog. The tongue may instead extend from the box with the dog projecting from the lid, depending on the depth of each.

### BRIEF DESCRIPTION OF DRAWINGS

The features and advantages of the enclosure disclosed in this application will be apparent from the following description taken in connection with the Figures wherein:

FIG. 1 is a perspective illustration of an electrical enclosure made following the teachings of this disclosure with the lid closed on the box.

FIG. 2 is a perspective illustration of the enclosure of FIG. 1 showing the lid opened to reveal the interior of the box.

FIG. 3 is a perspective illustration of the lid viewed from below showing a tongue that forms part of the lid with a finger lift.

FIG. 4 is a perspective illustration of a box viewed from above forming a part of the enclosure of FIG. 1.

FIG. 5 is a cross-sectional view of portions of the lid and box of FIG. 1.

### DETAILED DESCRIPTION

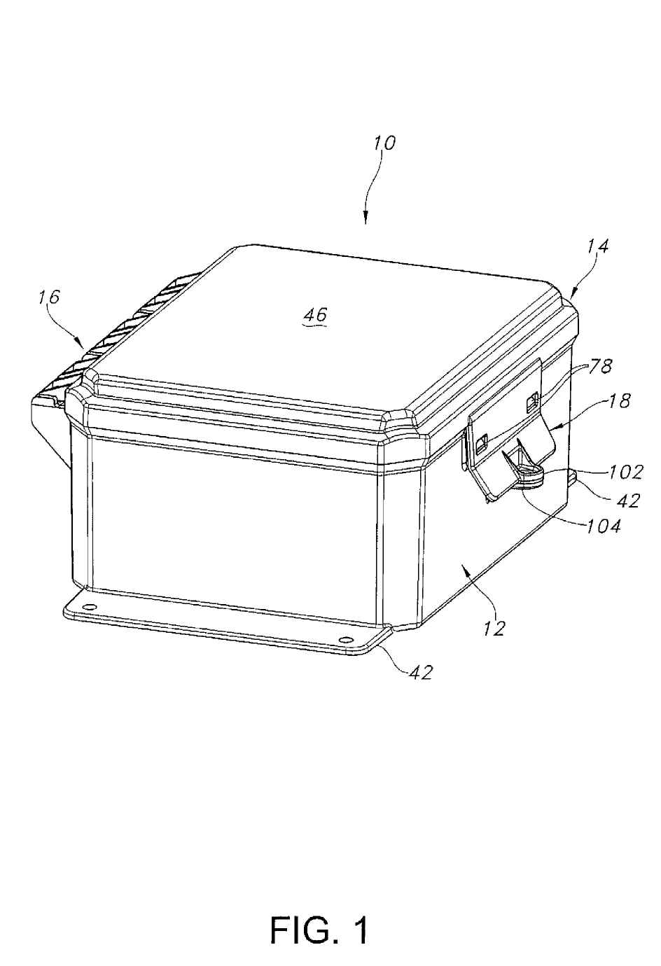

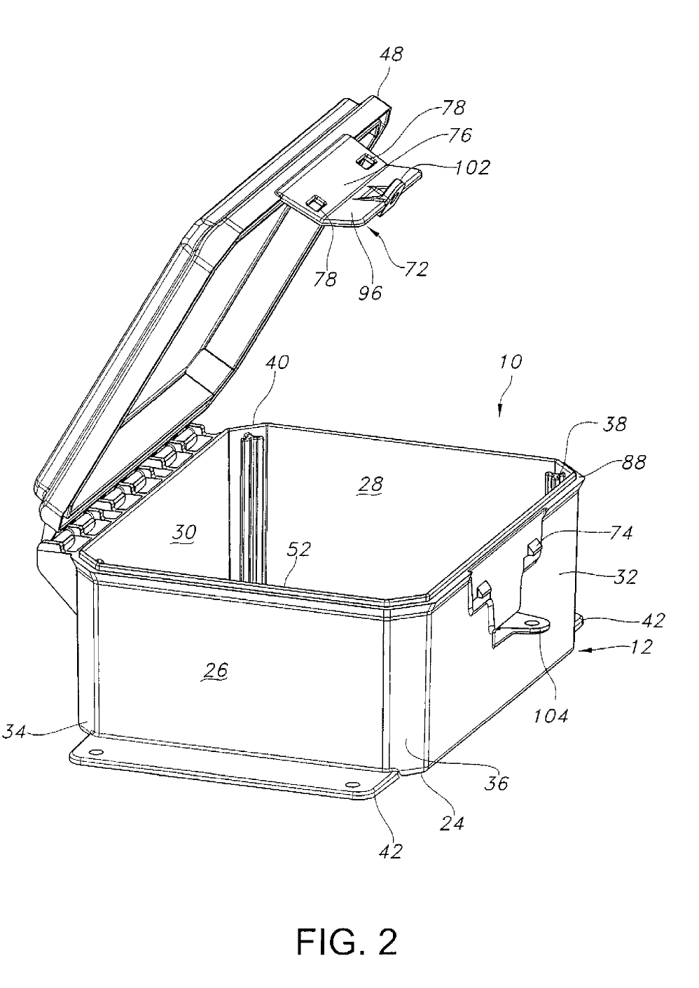

FIG. 1 illustrates an electrical enclosure 10 constructed following the teachings of this disclosure. The enclosure 10 (except for a gasket described below) is fabricated entirely of a thermoplastic material, providing resistance to impact, flame, water, and corrosion sufficient to meet the NEMA 4× standard. The enclosure is thus free of metal inserts to receive screws, inserts which add considerably to the cost of manufacturing enclosures that require them. The enclosure includes a box 12 and a lid 14. The box 12 and lid 14 are connected by a hinge 16 which allows the lid to move between a closed position shown in FIG. 1 and an open position shown in FIG. 2. A snap closure 18 (FIG. 1) secures the lid in a closed position.

The box 12 includes a bottom 24 (FIG. 2), side walls 26 and 28, back wall 30, and front wall 32. These walls may either join each other directly or may be joined by short diagonal walls 34, 36, 38, and 40, as shown. However the front, back, and side walls are joined to the bottom 24, the result is a container that has only an open top, with seams between the walls and bottom that are water tight and air tight.

The box 12 may conveniently be of unitary construction formed in an injection molding process using a thermoplastic material such as BMC or a polycarbonate. One advantage of using a polycarbonate, such as PCUV-C3, is that holes can be readily formed in the enclosure to suit individual applications using ordinary tools. While the box 14 may be air and water tight as initially formed, it is understood that, in general, openings may be made to accommodate wires that must pass through the walls of the box. Those of ordinary skill in the art know and appreciate how to make these openings air and water tight if the application requires it.

For mounting purposes, the box 12 also includes a pair of mounting flanges 42 that project as shown in FIGS. 1 and 2 flush with the bottom wall 24. Such positioning of the flanges 42 may be convenient for most applications. By making the appropriate changes in the tooling, the flanges 42 can be positioned elsewhere if a particular application requires it, or eliminated entirely.

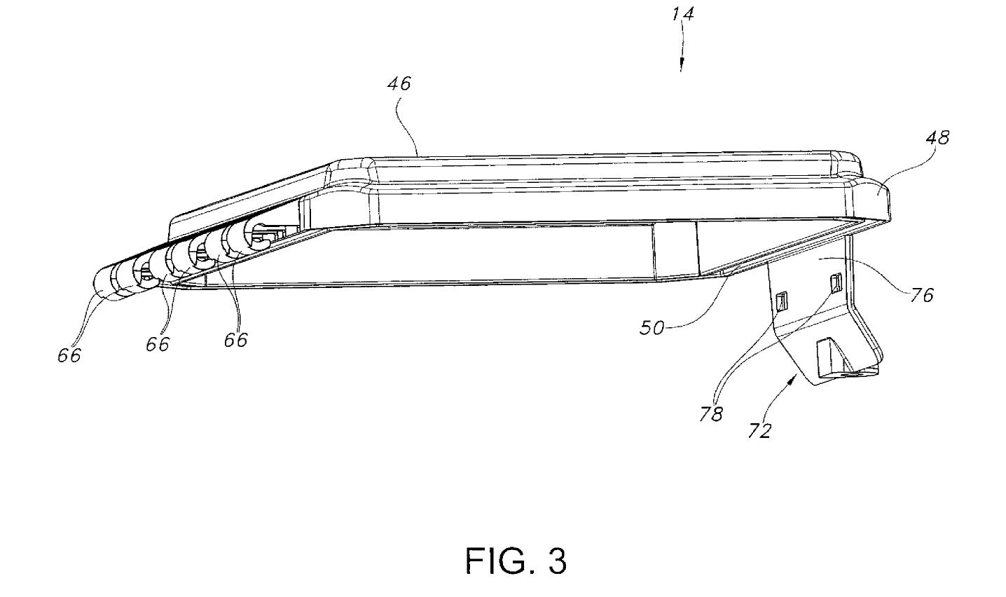

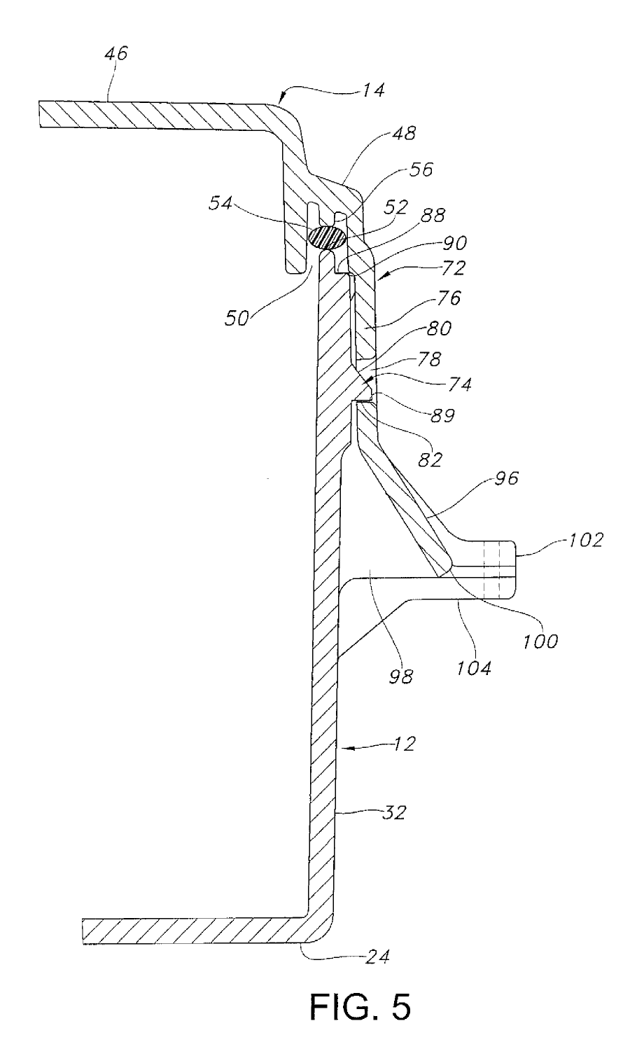

Like the box 12, the lid 14 (FIG. 3) is made of thermoplastic material such as the polycarbonate PCUV-3C. The lid 14 includes a generally planar top wall 46 and a peripheral wall 48. The peripheral wall 48 is shaped to follow the contours of the top edges of the walls 26, 28, 30, 32, 34, 36, 38, and 40 (FIG. 2) of the box 12. The lower edge of the peripheral wall 48 includes a slot 50 (FIGS. 3 and 5) which receives the top edge 52 of the walls 26-40 of the box 12, as well as a resilient gasket 54. A short stub wall 56 may rise inside the slot 50 to assure the gasket 54 is properly compressed when the lid is in the closed position.

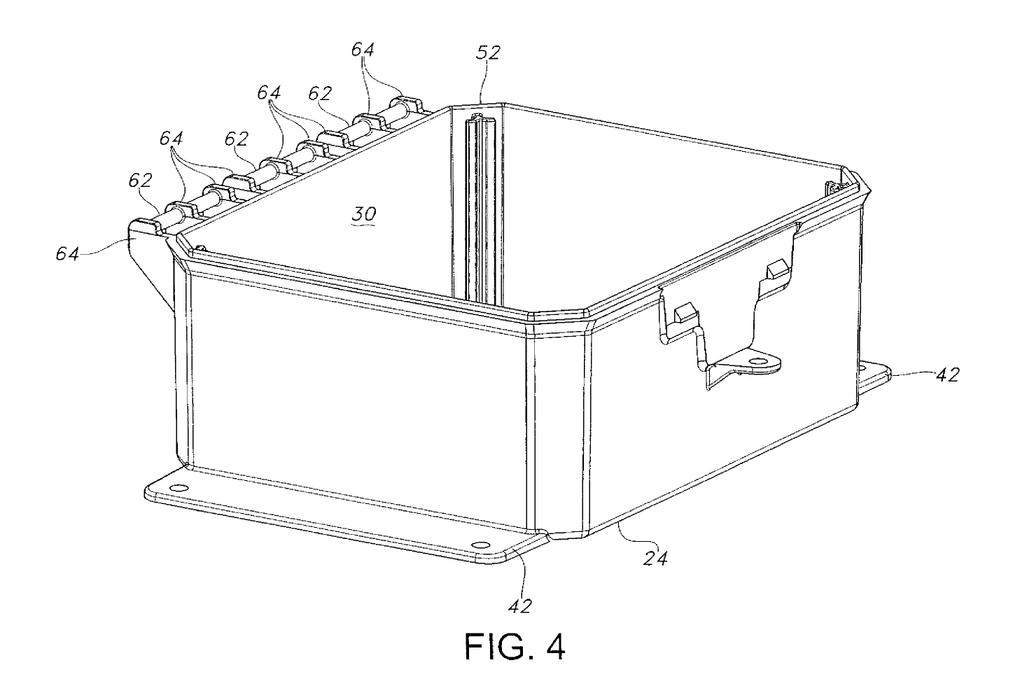

The box 12 and lid 14 are joined by a hinge 16. FIG. 1. The hinge 16 permits the lid 14 to rotate 180° or more from the closed position shown in FIG. 1 through the partially open position shown in FIG. 2 to a fully open position allowing easy access to the interior of the enclosure 10. The hinge 16 includes a series of coaxial rods at 62 (FIG. 4) supported by flanges 64 that project from the backwall 30 of the box 12. The flanges 64 are located so that the axis of the rods is approximately coplanar with the top edge 52 of the walls 26-40 of the box 12.

The lid 14 (FIG. 3) carries hooks 66 projecting from the lid. The hooks 66 snap over the rods 62 and enable the lid to rotate about the axis of the rods from an open position as shown in FIG. 2 to the closed position shown in FIG. 1. The hooks are integral with the lid, and made of the same thermoplastic material. It will be readily appreciated that the hooks and rods could easily be reversed, with the rod elements being part of the lid 14 and the hook elements being part of the box 12.

The snap closure 18 includes a tongue 72 that projects from the lid 14 and dogs 74 that extend outward from the front wall 32 of the box 12. The tongue 72 has a proximal portion 76 that is integral with the peripheral wall 48 of the lid 14 and is positioned so that it is generally parallel to the front wall 32 of the box 12 when the lid is in the closed position.

The dogs 74 each have a ramp shape with an inclined surface 80 rising away from the front wall 32 of the box 12 and a bottom wall 82 that is generally normal to the front wall of the box. The openings 78 in the tongue each are defined in part by a respective bottom surface 89 that mates with the bottom wall 82 of the dogs. As the lid 14 is closed, the tongue 72 rides up along the inclined surface 80, the tongue bending elastically as it does so, until the bottom surface 89 of the opening 78 reaches and snaps over the bottom wall 82 of the dogs 74. The bottom surface 89 and a bottom wall 82 are essentially parallel to each other and perpendicular to the direction of any force that would tend open the lid, and they are effective to hold the lid closed.

The box 12 includes a peripheral stop surface 88 that surrounds the top edge 52 of the box 12. The stop surface 88 is located so that it engages the bottom face 90 of the peripheral wall 48 of the lid 14 when the gasket 54 has been compressed the desired amount. Cooperation between the stop surface 88 in the bottom face 90 thus prevents over compression of the gasket 54. The opening 78 snaps over the bottom wall 82 of the dogs only when the bottom face 90 of the lid contacts the stop surface 88.

The tongue 72 has a finger lift 96 that makes it possible to manually release the proximal portion 76 of the tongue from the dogs 74. The finger lift 96 is integral with the proximal portion 76 and extends at an angle of about 30° from the plane of the front wall 32 of the box 12 when the lid 14 is closed. The angle of the finger lift creates a space 98 between the bottom edge 100 and front wall 32 of the box 12. The bottom edge 100 is far enough away from the bottom face 90 of the peripheral wall 48 of the lid that it provides sufficient mechanical advantage to enable a worker to prise the tongue 72 away from the front wall 32 of the box using his or her fingertips; no tool is required.

As illustrated, the proximal portion 76 of the tongue 72 is a rectangular planar element, and the finger lift 96 is similarly shaped. The two openings 78 (and the two dogs 74) are spaced apart to distribute compressive forces on the gasket 54. A box that is larger or smaller than the box 12 may require more or fewer openings and dogs.

The enclosure also is provided with a matching pair of ears or hasp members 102 and 104 which extend from the finger lift 96 and the box 12, respectively. The ears 102 and 104 line up when the lid 14 is in the closed position. Each ear includes a through hole which aligns with its mate when the lid is closed so that a fastener or locking device may be inserted.

The depth of the box and lid may be varied to accommodate different applications. With a lid of sufficient depth, the dogs 74 could project from the lid and the tongue could form an extension of the box. Viewed another way, this is the approximate equivalent of placing the mounting flanges on the lid, rather than on the box, as shown.

Accordingly, it should be understood that methods and apparatus described herein and shown in the accompanied drawings are intended as exemplary embodiments and not as limitations. Those skilled in the art will recognize that further modifications made in detail and form are possible without departing from the spirit and scope of the invention.

What is claimed is:

1. An electrical enclosure comprising
a box and a lid hinged to the box,
the lid configured to move between an open position and a closed position, the lid having a front face, and the box having a front face, the front face of the box and the front face of the lid being substantially parallel when the lid is in the closed position,
the enclosure further comprising a catch assembly to hold the lid closed, the catch assembly including a dog projecting from the front of one of the box and lid, the dog having a engagement face generally transverse to the front face of the one of the box and the lid from which it projects and a ramp leading from said front face to said engagement face,
the catch assembly further including a tongue connected to and projecting from the front face of the other of the lid and box, the tongue being resiliently bendable from an initial position in which the tongue is generally parallel to said front face to a flexed position in which it extends at an angle to said front face,
the tongue having an opening to receive the dog when the lid is in the closed position,
the tongue configured to be resiliently deformed from its initial position by contact with the ramp on the dog as the lid is moved from the open position to the closed position,
contact between the opening in the tongue and the engagement face of the dog preventing the lid from moving from the closed position when the tongue is in its initial position and the lid is closed, and
the tongue including an extension having a gripping surface for manually gripping the tongue to bend it from its initial position to its flexed position to release the opening from the engagement surface of the dog and so permit the lid to move from its closed position.

2. The enclosure of claim 1 wherein the tongue extends at an angle to the front faces of the lid and box when the lid is in the closed position and provides a free edge that can be manually gripped.

3. The enclosure of claim 3 wherein the angle between the tongue and the faces of the box and lid when the lid is in the closed position defines a space between the tongue and the face from which the dog projects when the lid is closed, the space being proportioned to receive a fingertip so that force can be applied to the tongue to bend it from its initial position to its flexed position.

4. The enclosure of claim 3 wherein the opening in the tongue is located between the connection of the tongue with the one of the lid and box to which the tongue is connected and the extension of the tongue.

5. The enclosure of claim 4 wherein the box includes a bottom and two sides, and further the box includes a pair of mounting flanges extending from the sides.

6. The enclosure of claim 5 wherein the mounting flanges are substantially coplanar with the bottom of the box.

7. The enclosure of claim 4 wherein the extension includes a first hasp member and the one of the box and lid from which the dog projects includes a second hasp member, the two hasp members each having a passageway proportioned to receive a locking pin, the two passageways being aligned when the lid is in its closed position, the hasp on the extension extending beyond the free edge of the extension.

8. A electrical enclosure comprising a box and a lid both formed essentially of a polycarbonate material,
the box having opposed front and back walls, side walls connected to the front and back walls and a bottom integrally formed with the front, side and back walls, the sidewalls having top edges at least partially defining an opening at the top of the box,
the lid having a top wall and a peripheral wall configured to engage the top edges of the walls,
a resilient seal disposed between the peripheral wall of the lid and the top edges of the walls of the box,
a hinge connecting the lid to the box, the hinge comprising a rod element defining a hinge axis and integrally formed with one of the lid and box and a hook element proportioned to engage the rod element, the hook element being integrally formed with the other of the box and lid,
the hinge positioned along the back wall of the box and enabling the lid to rotate about the hinge axis between open and closed positions,
the enclosure further including a manually operable snap closure, the closure including a dog projecting from the front wall of the box and a tongue extending from the lid and having an opening to receive the dog,
the tongue having a proximal portion and a distal, finger lift portion,
the proximal portion of the tongue being integrally formed with the lid,
the finger lift portion being integrally formed with the proximal portion and extending at an angle to the wall of the box from which the dog projects and having a terminal edge sufficiently spaced from the front wall of the box when the lid is in the closed position to enable manual release of the opening from the dog,
the opening in the tongue being located between the terminal edge of the tongue and the peripheral wall of the lid.

9. An electrical enclosure including a box having an open side, a lid configured to close the open side of the box, and a resilient gasket disposed between the lid and box to seal the joint between the lid and box when the lid closes the box,
the box being formed essentially of thermoplastic material,
the lid being formed essentially of thermoplastic material,
the lid and box including cooperating hinge elements that permit the lid to swing between a closed position in which the lid closes the box and an open position in which the interior of the box is accessible through the open side,
the box having a face from which at least one dog projects to retain the lid in the closed position,
the lid including a tongue that extends from it, the tongue including a fixed end portion connected with the lid and a free end portion remote from the fixed end portion, the fixed end portion being substantially parallel to the face of the box when the lid is in the closed position and the free end portion extending away from the face of the box when the lid is in the closed position,
the fixed end portion of the tongue including an opening for receiving the dog, the free end portion having a surface by which a user's fingertips may engage the tongue to prise it away from the face of the box to free the opening in fixed end portion of the tongue from the dog, thereby enabling the lid to be moved from the closed position to an open position.

10. The electrical enclosure of claim 9 wherein the box includes rails for securing electrical components within the box, the rails being formed essentially of the same material as the box.

11. The electrical enclosure of claim 9 where in the box and the lid are formed of a polycarbonate material.

12. The electrical enclosure of claim 9 wherein the gasket is captured in a recess formed in one of the lid and box, and the lid and box include stop surfaces that contact each other when the lid is in the closed position to limit compression of the gasket.

13. The electrical enclosure of claim 12 wherein the opening in the tongue is aligned with the dog on the face of the enclosure only when the lid is in the closed position and the stop surfaces on the lid and box are in contact with each other.

14. An electrical enclosure including a box having an open side, a lid configured to close the open side of the box, and a resilient gasket disposed between the lid and box to seal the joint between the lid and box when the lid closes the box,
the box being formed essentially of polycarbonate material,
the lid being formed essentially of a polycarbonate material,
the lid and box including cooperating hinge elements that permit the lid to swing between a closed position in which the lid closes the box and an open position in which the interior of the box is accessible through the open side,
the gasket being captured in a recess formed in one of the lid and box,
the lid and box including stop surfaces that contact each other when the lid is in the closed position to limit compression of the gasket,
the box including rails for securing electrical components within the box, the rails being integrally formed with the box,
the box having a face from which at least one dog projects to retain the lid in the closed position,
the lid including a tongue that extends from it, the tongue including a fixed end portion connected with the lid and a free end portion remote from the fixed end portion, the fixed end portion being substantially parallel to the face of the box when the lid is in the closed position and the free end portion extending away from the face of the box when the lid is in the closed position,
the fixed end portion of the tongue including opening for receiving the dog,
the opening in the tongue being aligned with the dog on the face of the enclosure only when the lid is in the closed position and the stop surfaces on the lid and box are in contact with each other,
the free end portion having a surface by which a user's fingertips may engage the tongue to prise it away from the face of the box to free the opening in fixed end portion of the tongue from the dog, thereby enabling the lid to be moved from the closed position to an open position.

15. The electrical enclosure of claim 14 wherein the box includes mounting flanges integrally formed with and extending from the exterior of the box.

16. The electrical enclosure of claim 15 wherein the lid includes a generally planar surface and the flanges lie in a plane that is parallel to the planar surface of the lid when the lid is in the closed position.
